(19) United States
(12) Patent Application Publication
(10) Pub. No.: US 2007/0208726 A1
(43) Pub. Date: Sep. 6, 2007

(54) Enhancing search results using ontologies

(75) Inventors: Muralidhar Krishnaprasad, Fremont, CA (US); Joaquin A. Delgado, Santa Clara, CA (US); Meeten Bhavsar, Emerald Hills, CA (US)

Correspondence Address: MCDONALD HOPKINS CO., LPA, 600 SUPERIOR AVE., E., SUITE 2100, CLEVELAND, OH, 44114, US

(73) Assignee: ORACLE INTERNATIONAL CORPORATION, REDWOOD SHORES, CA (US)

(21) Appl. No.: 11/648,981

(22) Filed: Jan. 3, 2007

Related U.S. Application Data
(60) Provisional application No. 60/777,988, filed on Mar. 1, 2006.
(60) Provisional application No. 60/853,489, filed on Oct. 20, 2006.

(51) Int. Cl. G06F 17/30

(52) U.S. Cl. 707/4

(57) ABSTRACT

Systems, methods, and other embodiments associated with query processing in light of an ontology are described. One example system includes a data store that stores both data concerning entities and data concerning relationships between the entities. The data may be logically arranged as an ontology and thus may include nodes and labeled relationships. The system may also include a query processing logic that can control a search logic to search for documents relevant to a query. Control exercised by the query processing logic may depend, at least in part, on data in the ontology.

### CROSS REFERENCE TO RELATED APPLICATIONS

This application claims the benefit of U.S. Provisional Patent Application Ser. No. 60/777,988 filed Mar. 1, 2006, titled “Systems and Methods For Searching”, and also claims the benefit of U.S. Provisional Patent Application Ser. No. 60/853,489 filed Oct. 20, 2006, titled “Query Processing With Ontology”.

### BACKGROUND

Conventional query processing may include relaxation, expansion, and so on in an attempt to increase the likelihood of receiving relevant results for a query. For example, a thesaurus may be consulted to find synonyms for a query term and then results may be searched for based on the original term and/or the additional synonym term(s).

However, words may mean different things to different people and may even mean different things to the same person at different points in time. Thus, synonyms may yield varied results, especially when taken out of context. Consider that the word “suit” may mean one thing to a poker player and another thing to a tailor. Similarly, the word “suit” may mean one thing to an attorney while at a tailor shop but may mean another thing to an attorney when preparing for trial. Thus, context may be relevant to understanding how a word is used and thus to determining which documents may be relevant to a query. However, synonyms for query terms like “suit” would likely conventionally be selected context free, yielding questionable improvements to document relevance.

### BRIEF DESCRIPTION OF THE DRAWINGS

The accompanying drawings, which are incorporated in and constitute a part of the specification, illustrate various example systems, methods, and other embodiments of various aspects of the invention. It will be appreciated that the illustrated element boundaries (e.g., boxes, groups of boxes, or other shapes) in the figures represent one example of the boundaries. One of ordinary skill in the art will appreciate that in some embodiments one element may be designed as multiple elements, multiple elements may be designed as one element, an element shown as an internal component of another element may be implemented as an external component and vice versa, and so on. Furthermore, elements may not be drawn to scale.

FIG. 1 illustrates basic ontology concepts.

FIG. 2 illustrates a portion of an ontology.

FIG. 3 illustrates an example query processing system that includes a query processing logic and a data store that stores an ontology.

FIG. 4 illustrates an example query processing system that includes a query processing logic, a search logic, and a data store that stores an ontology.

FIG. 5 illustrates an example query processing system that includes a data store that stores an ontology arranged with two or more views.

FIG. 6 illustrates an example computing environment in which portions of example systems and methods illustrated herein may operate.

FIG. 7 illustrates an example method associated with query processing with an ontology.

FIG. 8 illustrates an example method associated with query processing with an ontology.

FIG. 9 illustrates an example method associated with query processing with an ontology.

### DEFINITIONS

The following includes definitions of selected terms employed herein. The definitions include various examples and/or forms of components that fall within the scope of a term and that may be used for implementation. The examples are not intended to be limiting. Both singular and plural forms of terms may be within the definitions.

“Document”, as used herein, refers to an item of information. A document may by, for example, a file, a web page, an email, a spread sheet, and so on.

“Enterprise”, as used herein, refers to a set of computing resources belonging to an organization, where the organization may be a single entity and/or a formally defined collection of entities, and where the computing resources may include repositories of data and logic for processing data available in those repositories. An enterprise has identifiable boundaries and identifiable ownership.

“Entity”, as used herein, refers to something that has a distinct, independent existence and either an objective or conceptual reality. An entity may be, for example, a tangible thing (e.g., person, automobile), or an intangible thing (e.g., job, age).

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

“Machine-readable medium”, as used herein, refers to a medium that participates in directly or indirectly providing signals, instructions and/or data that can be read by a machine (e.g., computer). A machine-readable medium may take forms, including, but not limited to, non-volatile media (e.g., optical disk, magnetic disk), and volatile media (e.g., semiconductor memory, dynamic memory). Common forms of machine-readable mediums include floppy disks, hard disks, magnetic tapes, RAM (Random Access Memory), ROM (Read Only Memory), CD-ROM (Compact Disk ROM), and so on.

“Logic”, as used herein, includes but is not limited to hardware, firmware, software and/or combinations thereof to perform a function(s) or an action(s), and/or to cause a function or action from another logic, method, and/or system. Logic may include a software controlled microprocessor, discrete logic (e.g., application specific integrated circuit (ASIC)), an analog circuit, a digital circuit, a programmed logic device, a memory device containing instructions, and so on. Logic may include a gate(s), a combinations of gates, other circuit components, and so on. In some examples, logic may be fully embodied as software. Where multiple logical logics are described, it may be possible in some examples to incorporate the multiple logical logics into one physical logic. Similarly, where a single logical logic is described, it may be possible in some examples to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more computer instructions and/or processor instructions that can be read, interpreted, compiled, and/or executed by a computer and/or processor. Software causes a computer, processor, or other electronic device to perform functions, actions and/or behave in a desired manner. Software may be embodied in various forms including routines, modules, methods, threads, and/or programs. In different examples software may be embodied in separate applications and/or code from dynamically linked libraries. In different examples, software may be implemented in executable and/or loadable forms including, but not limited to, a stand-alone program, an object, a function (local and/or remote), a servelet, an applet, instructions stored in a memory, part of an operating system, and so on. In different examples, computer-readable and/or executable instructions may be located in one logic and/or distributed between multiple communicating, co-operating, and/or parallel processing logics and thus may be loaded and/or executed in serial, parallel, massively parallel and other manners. Software, whether an entire system or a component of a system, may be embodied as an article of manufacture and maintained or provided as part of a machine-readable medium.

### DETAILED DESCRIPTION

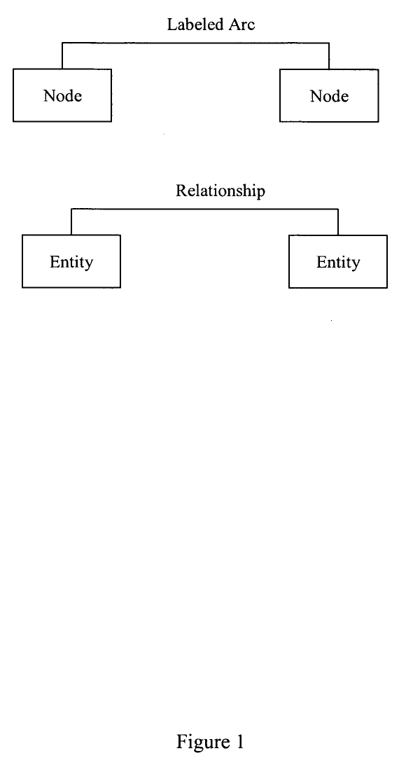

Example systems and methods concern query processing when an ontology is available. An ontology facilitates representing a hierarchical classification of entities using labeled relationships between entities. FIG. 1 illustrates the basic building blocks of an ontology, nodes connected by a labeled arc. Nodes represent information concerning entities and arcs represent information concerning relationships between the entities. An ontology may store information about things (e.g., people) and relationships between the things (e.g., parent of, child of, sibling of). Thus, an ontology may be used to manipulate (e.g., expand, refine) a query or to control how a search will proceed. For example, given a query term, additional terms and/or related items may be identified using an ontology. For example, given a first piece of information provided in a query (e.g., person name), a second piece(s) of information (e.g., child name) can be found by traversing a labeled relation (e.g., parent of) from a node corresponding to the first piece of information. Then, a search can be performed based on the original query term, the additional terms, and/or the related items. Thus, a query seeking documents concerning a parent and a child may yield more relevant results when an ontology provides child information to help control a search.

Consider a query presented to an enterprise search engine that is tasked with searching an enterprise Intranet. A conventional search may yield a first set of documents relevant to a query. Where an ontology is available, a second more relevant set of documents relevant to the query may be produced by accepting additional qualifiers in the query by manipulating the query in light of the ontology and/or by controlling a search based on information available in the query and the ontology. The second set may be more relevant because it considers refined information and/or related information retrieved from an ontology.

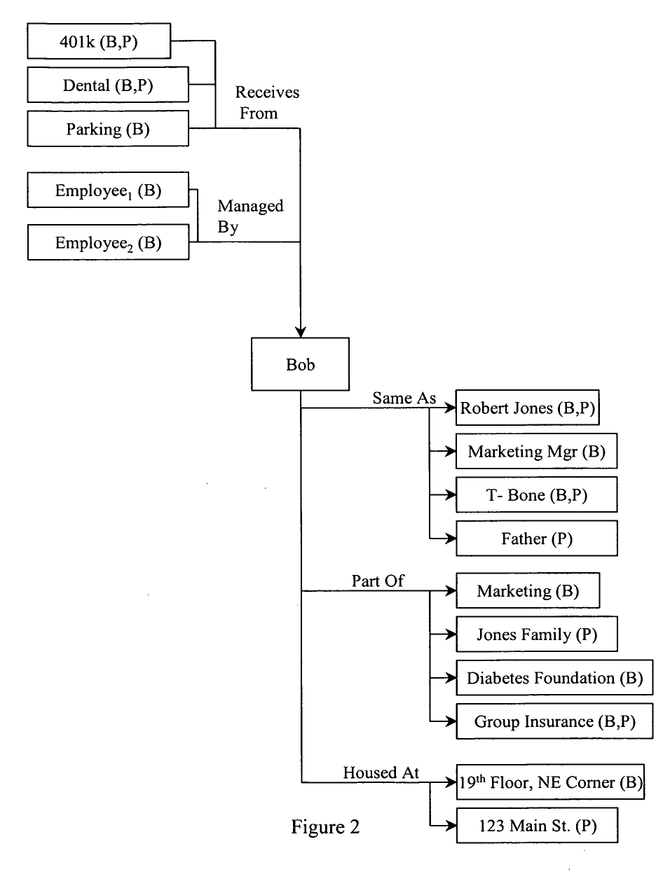

Additional qualifiers may include, for example, an explicit request to use a particular ontology or to view an ontology from a particular point of view. For example, two ontologies may be available to an enterprise (e.g., a personal ontology, a business ontology) and/or two views (e.g., personal, business) of a single ontology may be available. See, for example, FIG. 2, which illustrates a portion of an ontology that has both a business (B) view and a personal (P) view. A query may indicate which ontology and/or ontology view it would like to support the query. In one example, a user may be presented with information concerning ontologies and/or ontology views that are available and may choose from those available.

Additional qualifiers may also include, for example, relationships to be explored when expanding and/or refining a query. In one example, a user may have a priori knowledge of an ontology and its available relationships and thus may indicate which relationship(s) to use to navigate in the ontology to seek additional information. For example, a user may know that an ontology has a “part of” relationship and thus may present a query with a query term (e.g., person name) and an ontology relationship (e.g., part of) to use to navigate in the ontology. Query processing may then include producing a query that searches for relevant documents based on the query term and data found by traversing the “part of” relationship to find nodes connected to a node storing data matching the query term by a labeled relation matching the provided ontology relation. For example, it may be determined that a person is part of a family, part of a company, part of a civic organization, and part of a health insurance plan. Thus, documents relevant to the person and to these relationships may be provided in response to a query that specifies the “part of” relation to traverse. Additionally, and/or alternatively, query processing may include controlling a search logic based on the query and information located in the ontology by traversing a relationship.

When a user has knowledge of both the available ontology relationships and ontology views, then a user may even further refine their query. For example, a query may specify a query term (e.g., person name), an ontology relationship (e.g., part of) and an ontology view (e.g., business). Thus, the “part of” relationships relevant to the business view (e.g., company, health insurance plan) will determine, at least in part, the documents returned as relevant to the user while the “part of” relationships relevant to the personal view (e.g., family) may not contribute. Note that some views may have some overlap.

When the ontology view is not explicitly specified, an automated determination concerning ontology choice and/or ontology view may be made. For example, if semantic information associated with a query is available, then this semantic information may guide the ontology choice. For example, a first query made from a CEO desktop concerning an employee may provide context that a business view is desired while a second query made from a child care coordinator desktop may provide context that a personal view is desired. In one example, if no context information is available and/or if a view determination can not be made, then a user may be provided with information concerning available ontology views. This information may be provided in a manner (e.g., drop down selection box) that facilitates selecting from the available choices.

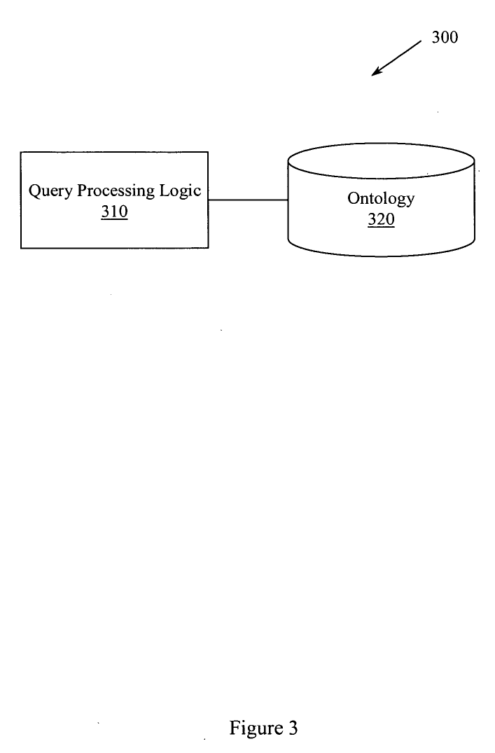

FIG. 3 illustrates a query processing system 300 that includes a data store 320 that stores an ontology. Data store 320 may store a first data set that stores information concerning entities. For example, the first data set may store names, titles, ages, addresses, dollar amounts, weights, and so on. Data store 320 may also store a second data set that stores information concerning relationships between entities. For example, the second data set may store information concerning parent/child relationships, “part of” relationships, “same as” relationships, “employed by” relationships, “lives at” relationships, and so on. In one example, members of the first data set and members of the second data set are logically arranged as an ontology. Thus, while the data may physically be stored in memory in a first arrangement, the data may logically be arranged in tables, lists, linked lists, and/or other data structures to implement an ontology.

System 300 also includes a query processing logic 310. Query processing logic 310 may control a search logic (e.g., enterprise search logic) to search for documents. In one example, the documents may belong to an enterprise. The search logic may be controlled to search for documents relevant to a query. The control may be based on data in the ontology stored in data store 320. For example, the query processing logic 310 may control the search logic based on information selected from the first data set. This would be entity data. The entity data may be selected from the first data set by traversing a relationship described in the second data set. A relationship(s) to traverse may be determined, for example, by an ontology relationship attribute in a query provided to the query processing logic 310. A relationship to traverse may be determined, alternatively and/or additionally, based on the relationship being a labeled relationship that is logically connected to a member of the first data set. Members of the first data set that store data matching at least a portion of the query (e.g., a query term) may be identified. Then, relationships connected to these members of the first data set may be identified and traversed. Then, entity information at the traversed end of the relationship may be identified. This information may then be used by the query processing logic 310 to control the search logic.

In one example, system 300 may provide information to users of the query processing logic 310. For example, the query processing logic 310 may selectively provide information concerning the presence of an ontology, ontology views that are available, relationships present in the ontology, and so on. Thus, a query processing logic 310 user may identify an ontology to use, an ontology view to use, ontology relationships to use, and so on, in response to being provided this information.

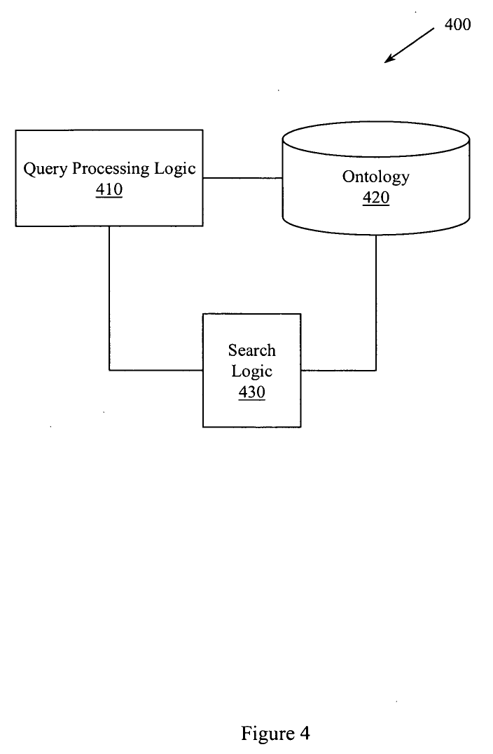

FIG. 4 illustrates a query processing system 400 that includes some elements like those described in connection with FIG. 3. For example, system 400 includes query processing logic 410 and a data store 420 that stores an ontology. Additionally, system 400 includes a search logic 430 that is operably connected to the query processing logic 410. In one example, query processing logic 410 may provide data and control signals to search logic 430. In another example, query processing logic 410 may control data store 420 to provide data to search logic 430 and/or to make data available to search logic 430. In one example, search logic 430 may be an enterprise search logic that includes a crawler logic.

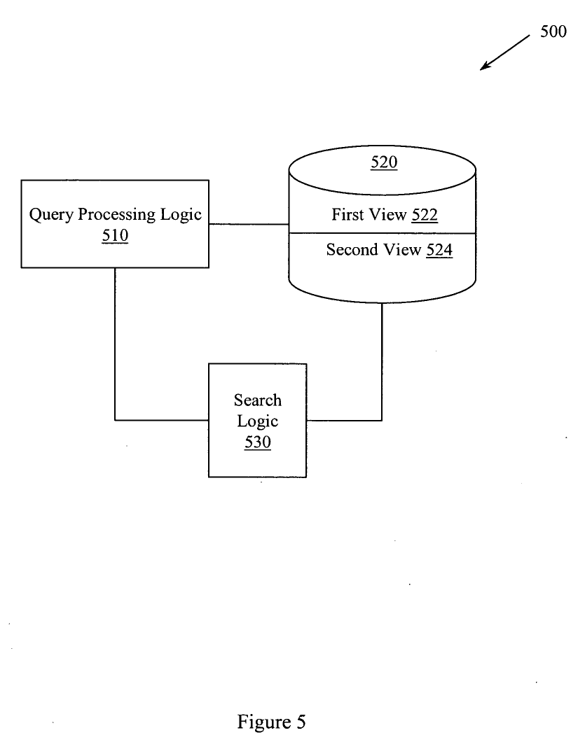

FIG. 5 illustrates a query processing system 500 that includes some elements like those described in connection with FIG. 4. For example, system 500 includes a query processing logic 510, a data store 520, and a search logic 530. In system 500, data store 520 may store an ontology arranged with multiple views. For example, a first view 522 may present a business view of an ontology while a second view 524 may provide a personal view. Recall that FIG. 2 illustrated a portion of an ontology that stored both personal view information (e.g., family title “Father”) and business view information (e.g., business title “Marketing Manager”).

While a data store 520 that stores two views is illustrated, it is to be appreciated that in some examples system 500 may include two or more data stores. Each of the data stores may store an ontology and/or an ontology view(s). With multiple ontologies and/or ontology views available, the query processing logic 510 may select a view based on an ontology selection attribute in a query. Additionally and/or alternatively, query processing logic 510 may select a view based on semantic information associated with a query. This semantic information may include, for example, context data. The context may be related to who a query provider is, from where they are placing a query, in what role they are placing a query, and so on. Thus, the context data may describe a query provider identity, a query provider location, a query provider task, and so on.

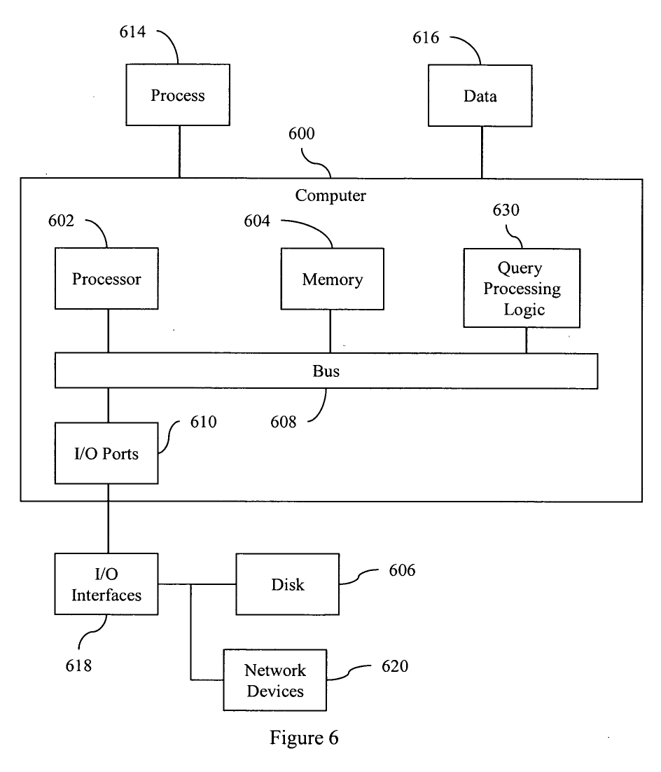

FIG. 6 illustrates an example computing device in which example systems and methods described herein, and equivalents, may operate. The example computing device may be a computer 600 that includes a processor 602, a memory 604, and input/output ports 610 operably connected by a bus 608. In one example, the computer 600 may include a query processing logic 630 configured to facilitate manipulating a query and/or to facilitate controlling a search. The manipulating and/or control may be based on information stored in an ontology. In different examples, the logic 630 may be implemented in hardware, software, firmware, and/or combinations thereof. Thus, the logic 630 may provide means (e.g., hardware, software, firmware) for storing an ontology. The means may include, for example, a data store, a database, a memory, and so on. Logic 630 may also provide means (e.g., hardware, software, firmware) for searching for documents. The means may include, for example, a crawler logic, a search logic, a database logic, and so on. Logic 630 may also provide means (e.g., hardware, software, firmware) for selectively controlling the means for searching. The means may include, for example, a logic, a computer, a computer program, and so on. While the logic 630 is illustrated as a hardware component operably connected to the bus 608, it is to be appreciated that in one example, the logic 630 could be implemented in the processor 602.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 may be, for example, a magnetic disk drive, a solid state disk drive, a floppy disk drive, a tape drive, a Zip drive, a flash memory card, a DVD, and/or a memory stick. Furthermore, the disk 606 may be a CD-ROM, a CD recordable drive (CD-R drive), a CD rewriteable drive (CD-RW drive), and/or a digital video ROM drive (DVD ROM). The memory 604 can store a process 614 and/or a data 616, for example. The disk 606 and/or the memory 604 can store an operating system that controls and allocates resources of the computer 600.

The bus 608 may be a single internal bus interconnect architecture and/or other bus or mesh architectures. While a single bus is illustrated, it is to be appreciated that the computer 600 may communicate with various devices, logics, and peripherals using other busses (e.g., PCIE, SATA, Infiniband, 1394, USB, Ethernet). The bus 608 can be types including, for example, a memory bus, a memory controller, a peripheral bus, an external bus, a crossbar switch, and/or a local bus.

The computer 600 may interact with input/output devices via the i/o interfaces 618 and the input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, and USB ports.

The computer 600 can operate in a network environment and thus may be connected to the network devices 620 via the i/o interfaces 618, and/or the i/o ports 610. Through the network devices 620, the computer 600 may interact with a network. Through the network, the computer 600 may be logically connected to remote computers. Networks with which the computer 600 may interact include, but are not limited to, a local area network (LAN), a wide area network (WAN), and other networks.

Some portions of the detailed descriptions that follow are presented in terms of method descriptions and representations of operations on electrical and/or magnetic signals capable of being stored, transferred, combined, compared, and otherwise manipulated in hardware. These are used by those skilled in the art to convey the substance of their work to others. A method is here, and generally, conceived to be a sequence of operations that produce a result. The operations may include physical manipulations of physical quantities. The manipulations may produce a transitory physical change like that in an electromagnetic transmission signal.

It has proven convenient at times, principally for reasons of common usage, to refer to these physical quantities, these electrical and/or magnetic signals, as bits, values, elements, symbols, characters, terms, numbers, and so on. These and similar terms are associated with appropriate physical quantities and are merely convenient labels applied to these quantities. Unless specifically stated otherwise, it is appreciated that throughout the description, terms including processing, computing, calculating, determining, displaying, automatically performing an action, and so on, refer to actions and processes of a computer system, logic, processor, or similar electronic device that manipulates and transforms data represented as physical (electric, electronic, magnetic) quantities.

Example methods may be better appreciated with reference to flow diagrams. While for purposes of simplicity of explanation, the illustrated methods are shown and described as a series of blocks, it is to be appreciated that the methods are not limited by the order of the blocks, as in different embodiments some blocks may occur in different orders and/or concurrently with other blocks from that shown and described. Moreover, less than all the illustrated blocks may be required to implement an example method. In some examples, blocks may be combined, separated into multiple components, may employ additional, not illustrated blocks, and so on. In some examples, blocks may be implemented in logic. In other examples, processing blocks may represent functions and/or actions performed by functionally equivalent circuits (e.g., an analog circuit, a digital signal processor circuit, an application specific integrated circuit (ASIC)), or other logic device. Blocks may represent executable instructions that cause a computer, processor, and/or logic device to respond, to perform an action(s), to change states, and/or to make decisions. While the figures illustrate various actions occurring in serial, it is to be appreciated that in some examples various actions could occur concurrently, substantially in parallel, and/or at substantially different points in time.

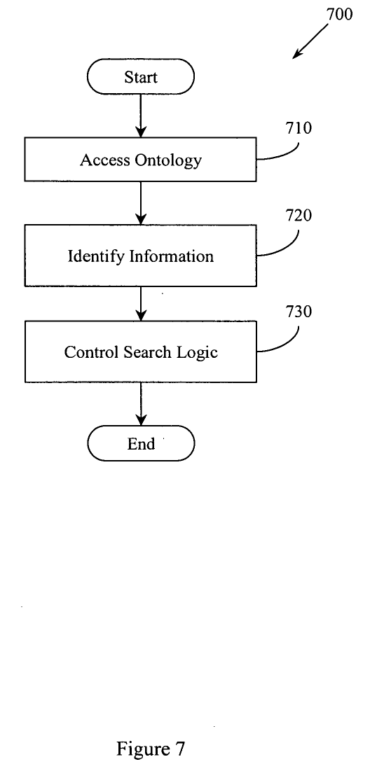

FIG. 7 illustrates a method 700 associated with query processing with an ontology. Method 700 may include, at 710, accessing an ontology. Accessing the ontology at 710 may include, for example, establishing data communications with a data store, establishing a network communication to a data store, providing security information that is validated before access is granted to a data store, establishing a live link to a logical location in which an ontology is located, and so on. Accessing the ontology at 710 may also include, for example, acquiring ontology identification information from the ontology. For example, information concerning ontologies that are available on a data store, ontology views that are available on a data store, and so on may be acquired. Additionally, information concerning ontology relationships may be acquired.

Method 700 may also include, at 720, identifying information in the ontology. The information identified is information that is related to a query for documents in the enterprise. For example, information related to a query element (e.g., query term) may be identified in the ontology. Identifying the information may include, for example, pattern matching a query term to information stored in locations corresponding to ontology nodes. Identifying the information may also include, for example, pattern matching a query term to information stored in locations corresponding to ontology arcs. Thus, a query may provide information concerning an entity and/or information concerning a relationship associated with an entity. This information may be used to manipulate a query and/or to control how a search for documents will proceed.

Therefore, method 700 may also include, at 730, controlling a search logic to search for documents based on a query, and/or on the information identified at 720. As described in connection with 720, the information may be identified by traversing a labeled relationship in the ontology. Consider a query that seeks documents concerning a person named Bob. In one example, the query may also include a query term “father”. Thus, the query may be looking for documents describing Bob and his roles. If the portion of the ontology illustrated in FIG. 2 was available, method 700 may identify, at 720, that “father” is connected to Bob by a “same as” relationship. Then, method 700 may also control 730 a search logic to seek out documents concerning Bob and information available by traversing other “same as” relationships. In this way, documents that describe “Robert Jones” may also be located, potentially increasing the relevance of documents returned in response to the query.

While FIG. 7 illustrates various actions occurring in serial, it is to be appreciated that various actions illustrated in FIG. 7 could occur substantially in parallel. By way of illustration, a first process could access an ontology, a second process could identify information in the ontology, and a third process could control a search logic. While three processes are described, it is to be appreciated that a greater and/or lesser number of processes could be employed and that lightweight processes, regular processes, threads, and other approaches could be employed.

In one example, a method may be implemented as processor executable instructions. Thus, in one example, a machine-readable medium may store processor executable instructions that if executed by a machine (e.g., processor) cause the machine to perform a method that includes accessing an ontology and identifying information related to a query for documents, where the information is stored in a data store as an ontology. The method may also include controlling a search logic to search for documents based on the query, and/or on information identified in the ontology. While this method is described being stored on a machine-readable medium, it is to be appreciated that other example methods described herein may also be stored on a machine-readable medium.

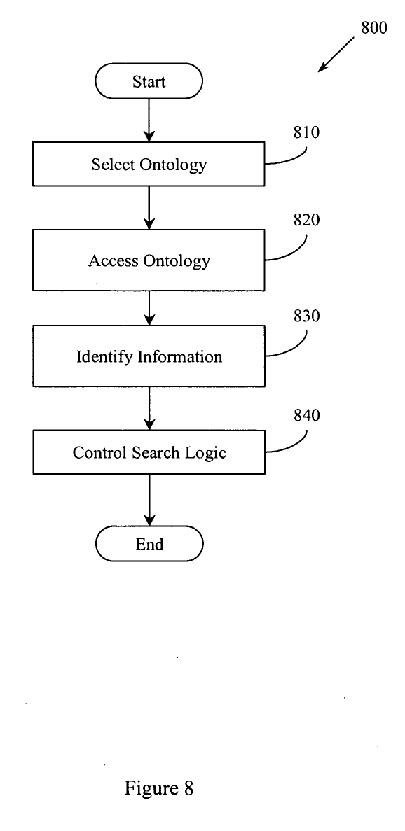

FIG. 8 illustrates a method 800 associated with query processing with an ontology. Method 800 includes some elements similar to those described in connection with FIG. 7. For example, method 800 includes accessing 820 an ontology, identifying 830 information in an ontology, and controlling 840 a search logic. Method 800 also includes additional actions. For example, method 800 includes, at 810, selecting an ontology to access.

In one example, the ontology to access may be selected based on ontology selection information provided in a query. A query may include a query term or query attribute that indicates that a particular ontology is to be selected. For example, a query may include a term (e.g., ontology=ont1, personal) that identifies both an ontology to access and a point of view from which the ontology is to be viewed. In another example, the ontology to select may be chosen based on context information associated with the query. The context information may include, for example, a query provider identity, a query provider role, a query provider task, and so on.

In some cases, a query provider may have information about ontologies that are available and thus may explicitly call out which ontology to use. In other cases, a query provider may not have this type of information. Thus, method 800 may also include providing information concerning ontologies that are available to the enterprise. Thus, selection of the ontology to access at 810 may be determined by a response to the provided information.

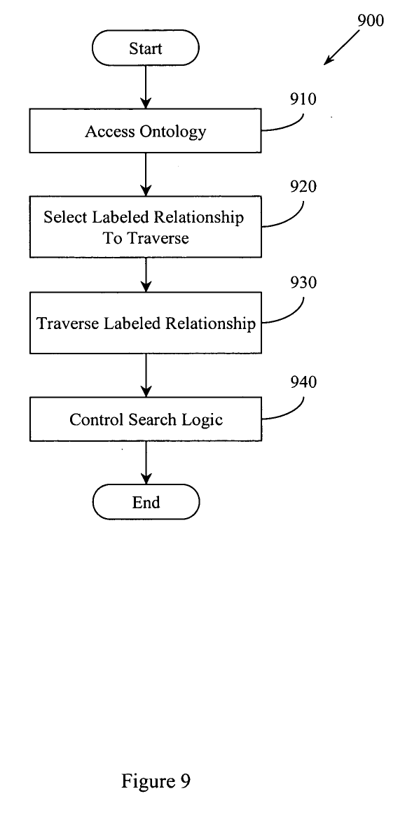

FIG. 9 illustrates a method 900 associated with query processing with an ontology. Method 900 includes some elements similar to those described in connection with FIG. 7. For example, method 900 includes accessing 910 an ontology and controlling 940 a search logic.

Method 900 may also include additional actions. For example, method 900 includes, at 920, selecting a labeled relationship to traverse in an ontology. In one example, information concerning the labeled relationship to traverse is provided as a query term and/or attribute. For example, a query may include language (e.g., ont_rel=“same as”) that identifies a labeled relationship to search for and to traverse. In another example, a labeled relationship may be selected based on context information associated with the query. For example, a query coming from a human resources payroll deduction desktop may provide context that a “receives from” relationship may be worth traversing. In another example, a labeled relationship may be selected based on that fact that it is logically connected to an ontology node that stores data matching a query term.

Consider again the ontology portion illustrated in FIG. 2, a query term “Diabetes Foundation” may be pattern matched to nodes in an ontology and be discovered to be logically connected to a “part of” relationship that leads to a node storing the data “Bob”. This would facilitate controlling a search logic to locate documents concerning not only the Diabetes Foundation but also people who are members of the Foundation.

In some cases, a query provider may have information about relationships available in an ontology. However, in other cases the user may not have that information and/or may have incorrect/incomplete information. Thus, in one example, method 900 may include providing information concerning labeled relationships that are available in an ontology. Thus, selecting 920 a labeled relationship may be based on a response to having provided the information concerning the available labeled relationships.

With a labeled relationship selected, method 900 may then proceed, at 930, to traverse the labeled relationship. In one example, the labeled relationship may be traversed starting at a location that stores data matching a query term and that ends at locations logically connected to that starting point by the labeled relationship.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. The term “and/or” is used in the same manner, meaning “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A system, comprising:
a data store to store a first data set concerning one or more entities and to store a second data set concerning one or more relationships between the one or more entities, where members of the first data set and members of the second data set are logically arranged as an ontology; and
a query processing logic to control a search logic to search for documents relevant to a query based, at least in part, on data in the ontology.

2. The system of claim 1, including the search logic, the query processing logic being operably connected to the search logic.

3. The system of claim 1, where the query processing logic controls the search logic based, at least in part, on information selected from the first data set.

4. The system of claim 3, the information being selected from the first data set based on traversing a relationship described in the second data set, the relationship being identified by an ontology relationship attribute in the query.

5. The system of claim 3, the information being selected from the first data set based on traversing a relationship described in the second data set, the relationship being selected based on the relationship being a labeled relationship logically connected to a member of the first data set, where the member stores data matching at least a portion of the query.

6. The system of claim 1, the ontology being arranged into two or more views.

7. The system of claim 6, where the query processing logic selects a view based on an ontology selection attribute in the query.

8. The system of claim 6, where the query processing logic selects a view based on semantic information associated with the query.

9. The system of claim 8, the semantic information including a context data.

10. The system of claim 9, the context data describing one or more of, a query provider identity, a query provider location, and a query provider task.

11. The system of claim 6, the query processing logic being configured to selectively provide information concerning one or more of, an ontology presence, and available ontology views.

12. The system of claim 6, the query processing logic being configured to selectively provide information concerning available ontology relationships.

13. A method, comprising:
accessing an ontology;
identifying information in the ontology, the information being related to a query for documents; and
controlling a search logic to search for documents based on one or more of, the query, and identified information in the ontology.

14. The method of claim 13, including selecting an ontology to access based on ontology selection information provided in the query.

15. The method of claim 13, including selecting an ontology to access based on context information associated with the query.

16. The method of claim 13, including:
providing information concerning one or more ontologies; and
selecting an ontology to access based on a response to providing the information concerning the one or more ontologies.

17. The method of claim 13, where identifying information in the ontology related to the query includes traversing a labeled relationship in the ontology.

18. The method of claim 17, where information concerning the labeled relationship to traverse is provided as a query attribute in the query.

19. The method of claim 17, including selecting the labeled relationship to traverse based on context information associated with the query.

20. The method of claim 17, including selecting the labeled relationship to traverse based on the labeled relationship being logically connected to an ontology node storing data matching a query term.

21. The method of claim 17, including:
providing information concerning one or more labeled relationships available in the ontology;
selecting a labeled relationship based on a response to providing the information concerning the one or more labeled relationships available in the ontology; and
traversing the labeled relationship in the ontology starting at a location that stores data matching a query term.

22. A machine-readable medium having stored thereon machine-executable instructions that if executed by a machine cause the machine to perform a method, the method comprising:
accessing an ontology;
identifying information in the ontology, the information being related to a query for documents; and
controlling a search logic to search for documents based on one or more of, the query, and identified information in the ontology.

23. A system, comprising:
means for storing an ontology;
means for searching for documents; and
means for selectively controlling the means for searching based, at least in part, on information stored in the ontology.
